(19) United States
(12) Patent Application Publication
(10) Pub. No.: US 2006/0227074 A1
(43) Pub. Date: Oct. 12, 2006

(54) Driving method of plasma display panel and plasma display device

(76) Inventors: Takashi Sasaki, Hiratsuka (JP); Yoshikazu Kanazawa, Kawasaki (JP); Akihiro Takagi, Kawaguchi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/387,905

(22) Filed: Mar. 24, 2006

(30) Foreign Application Priority Data
Mar. 25, 2005 (JP) JP2005-89416

(51) Int. Cl. G09G 3/28

(52) U.S. Cl. 345/60

(57) ABSTRACT

In a plasma display device including: a plasma display panel having scan electrodes, sustain electrodes, and address electrodes; scan electrode driving circuits; a sustain electrode driving circuit; and an address electrode driving circuit, each sub-field has a reset period, an address period in which scan pulses are sequentially applied to the scan electrodes, and address pulses are applied to the data electrodes in synchronization with the application to select cells to be turned on, and a sustain period in which the selected cells are turned on. An identical line detecting circuit for detecting display identical lines on which the turned-on cells on one line are identical in each sub-field is provided, and the scan electrode driving circuit simultaneously applies the scan pulses to a plurality of scan electrodes corresponding to the display identical lines in the address period.

### CROSS-REFERENCE TO RELATED APPLICATION

The present application claims priority from Japanese Patent Application No. JP 2005-089416 filed on Mar. 25, 2005, the content of which is hereby incorporated by reference into this application.

### TECHNICAL FIELD OF THE INVENTION

The present invention relates to a driving method of a plasma display panel (PDP) and a plasma display device (PDP device). More particularly, it relates to a technology for shortening a time required for an address operation of the PDP device.

### BACKGROUND OF THE INVENTION

A plasma display device (PDP device) has been put into practical use as a flat display and has been expected as a high luminance thin-type display. Since only whether cells are turned on or not can be controlled in the PDP device, when the grayscale display is to be performed on the PDP device, one display frame is divided into a plurality of sub-fields and the sub-fields for turning on are combined for each cell.

Methods for a PDP device include; an address/display non-separation method in which, during an address operation for selecting cells to be displayed (display cell) on each display line, the selected display cells on other display lines are turned-on; and an address/display separation method in which, after an address operation on all the display lines is finished, display is simultaneously performed on all the display lines. In the present invention, the PDP device using the address/display separation method will be described.

In a standard PDP device using the address/display separation method, each sub-field has a reset period in which all the cells are initialized into a uniform state, an address period in which display data is written to select display cells, and a sustain period in which display is performed based on the written data. In the sustain period, sustain pulses are applied to generate sustain discharges and the number of times of the sustain discharges determines the luminance.

Also, various types of the PDP device have been proposed such as three-electrode type, two-electrode type and others. In the three-electrode PDP device, a plurality of sustain (X) electrodes and scan (Y) electrodes are alternately arranged substantially in parallel to each other, a plurality of data (address) electrodes are arranged in a direction perpendicular to the X and Y electrodes, and cells are formed at the intersections of the X and Y electrodes and the address electrodes. When writing the display data, scan pluses are sequentially applied to the Y electrodes and address pluses are applied to the address electrodes of the cells to be displayed (display cell) in synchronization with the application of the scan pulses, thereby generating address discharges. Wall charges are formed by the address discharges in the vicinity of the X and Y electrodes of the display cells. When the sustain pulses are applied between the X and Y electrodes while alternately changing the polarities thereof, sustain discharges are generated in the display cells in which wall charges have been formed by the address discharges, but sustain discharges are not generated in the non-display cells in which wall charges are not formed. In the two-electrode PDP device, a plurality of scan electrodes are arranged substantially in parallel to each other, a plurality of data electrodes are arranged in a direction perpendicular to the scan electrodes, and cells are formed at the intersections of the scan electrodes and the data electrodes. When writing the display data, scan pluses are sequentially applied to the scan electrodes and address pluses are applied to the data electrodes of the display cells in synchronization with the application of the scan pulses, thereby generating address discharges. Wall charges are formed by the address discharges in the vicinity of the scan electrode and the data electrode of the display cell. When the sustain pulses are applied between the scan electrode and the data electrode while alternately changing the polarities thereof, sustain discharges are generated in the display cells in which wall charges have been formed by the address discharges, but sustain discharges are not generated in the non-display cells in which wall charges are not formed.

As described above, in any of three-electrode type and double-electrode type, the scan electrode and data electrode are provided, scan pulses are applied to the scan electrodes, and address pulses are applied to the data electrodes to select display cells. The present invention can be applied to the PDP device with such a structure.

Since basic structure and operation of a PDP device are described in details in Japanese Patent Application Laid-Open Publication No. 2003-122300 (Patent Document 1), further description thereof is omitted here.

As stated above, in a conventional PDP device, scan pulses are sequentially applied to the scan electrodes (Y) in the address period. Therefore, when the number of the Y electrodes is n and the width of the scan pulse is t μs, an address period in one sub-field is nt μs or longer. For example, if t=1 μs and n=100, the address period in one sub-field is 1 ms or longer. When one display field is composed of 10 sub-fields, the total address period in one display field is 10 ms or longer. Thus, the larger the number of the display lines, the longer the address period, which in turn shortens the sustain period and the reset period. This causes the problems that a peak luminance is decreased and a driving margin is narrowed.

The patent document 1 describes a structure in which non-display lines on which cells to be turned on do not exist are detected and scan pulses are not applied to the scan (Y) electrodes which correspond to the non-display lines, which makes it possible to shorten the address period.

Also, Japanese Patent Application Laid-Open Publication No. 2000-89721 (patent document 2) describes a method in which non-display lines on which cells to be turned on do not exist are detected, scan pulses are not applied to the scan (Y) electrodes which correspond to the non-display lines, and a time saved by shortening the address period is allocated to the sustain period.

Furthermore, Japanese Patent Application Laid-Open Publication No. 2000-347616 (patent document 3) describes a method in which scan pulses are simultaneously applied to adjacent plural scan electrodes irrespective of display data in the sub-fields with a lower luminance, thereby shortening the address period.

### SUMMARY OF THE INVENTION

According to the inventions disclosed in the patent documents 1 and 2, an address period can be shortened by the time which has been required for the application of the scan pulses to the non-display lines. However, further shortening of the address period has been demanded.

According to the invention disclosed in the patent document 3, though an address period in a predetermined sub-field can be decreased to 50% or less, a problem of degradation in display quality occurs since the display data is neglected.

An object of the present invention is to further shorten the address period without degrading the display quality.

In the driving method of a plasma display panel according to the present invention, in each sub-field, “display identical lines” on which cells to be turned on (turned-on cell) on one line are identical are detected, and the scan pulses are simultaneously applied to a plurality of scan electrodes which correspond to the display identical lines in the address period.

More specifically, the driving method of a plasma display panel according to the present invention is a driving method of a plasma display panel having a plurality of scan and sustain electrodes alternately arranged in parallel to each other and address electrodes arranged in a direction perpendicular to the plurality of scan and sustain electrodes, in which one display field includes a plurality of sub-fields, and each sub-field comprises: a reset period in which all cells are initialized; an address period in which scan pulses are sequentially applied to the scan electrodes, and address pulses are applied to the address electrodes in synchronization with the application of the scan pulses, thereby generating address discharges to select cells to be turned on; and a sustain period in which sustain discharges are repeatedly generated between the scan electrodes and the sustain electrodes of the turned-on cells selected in the address period, thereby turning on the cells, display identical lines on which the turned-on cells on one line are identical are detected in each sub-field, and the scan pulses are simultaneously applied to a plurality of scan electrodes corresponding to the display identical lines, in the address period.

FIG. 1 is a diagram for describing the principle of the present invention. The case where lines having a given grayscale are displayed as shown in FIG. 1 will be described as an example. In FIG. 1, scan electrodes extend in the lateral direction. In the areas A, C, E, and G, diagonal lines 2 are displayed. Therefore, since the positions of the cells to be turned on differ on the respective lateral display lines, these lines are not the display identical lines. In the area B, only longitudinal lines 3 are displayed. Therefore, since address data on the respective lateral display lines are identical, these lines are the display identical lines. In other words, in the area B, when the scan pluses are applied to the scan electrodes, the same address data are applied. Therefore, in the area B, the same address data can be applied by simultaneously applying the scan pulses to a plurality of scan electrodes. In the present invention, in the area B as mentioned above, the scan pulses are simultaneously applied to a plurality of scan electrodes to simultaneously generate address discharges on a plurality of display lines. Accordingly, it is possible to shorten the time required for the scanning of the area B. Specifically, if the width of one scan pulse is t μs and scan pulses are simultaneously applied to N scan electrodes, the address period can be shortened by (N−1)t μs. This holds true of the areas D and F.

The case where display lines on an image are identical has been described as an example with reference to FIG. 1, in other words, the case where display lines in all the sub-fields are identical has been described. However, the present invention is not limited to this example, but can be applied as long as display lines in each sub-field are identical.

The case where the display identical lines are continuous in the area has been described as an example with reference to FIG. 1. However, the present invention is not limited to this example, but can be applied to the case where the display identical lines are not continuous.

When the address period is shortened according to the present invention, the number of times of sustain discharges is increased to improve the luminance. However, the upper limit of electric power is restricted in general in a PDP device, and the number of times of sustain discharges is controlled so as not to exceed a predetermined electric power in accordance with the display load. In such a case, the number of times of the sustain discharges is increased only when the electric power is lower than the predetermined value. It is desirable that the electric power is controlled so as not to exceed the predetermined value even when the number of times of the sustain discharges is increased.

Also, when the address period is shortened according to the present invention, it is also preferable to improve the operation margin by widening the width of the scan pulse or lengthening the reset period.

In the PDP device, image data is expanded into the frame memory corresponding to a plurality of sub-fields. Therefore, the display identical lines are detected from image data expanded into the frame memory corresponding to a plurality of sub-fields.

According to the present invention, the address period of the PDP device can be shortened without degrading image quality. The length of the sustain period or the reset period and the width of the scan pulse can be increased by using the time saved by shortening the address period. By doing so, the peak luminance can be increased and the driving margin can be improved, which makes it possible to realize a PDP device with excellent quality and reliability.

### BRIEF DESCRIPTIONS OF THE DRAWINGS

FIG. 1 is a diagram for describing the principle of the present invention;

FIG. 2 is a diagram showing an entire structure of a plasma display device (PDP device) according to a first embodiment of the present invention;

FIG. 3A is a diagram showing the configuration of a sub-field of the PDP device according to the first embodiment;

FIG. 3B is a diagram showing the configuration of a sub-field of the PDP device according to the first embodiment;

FIG. 3C is a diagram showing the configuration of a sub-field of the PDP device according to the first embodiment;

FIG. 3D is a diagram showing the configuration of a sub-field of the PDP device according to the first embodiment;

FIG. 3E is a diagram showing the configuration of a sub-field of the PDP device according to the first embodiment;

FIG. 4 is a diagram showing driving waveforms of the PDP device according to the first embodiment;

FIG. 5 is a diagram showing the structure of a scan driver of the PDP device according to the first embodiment;

FIG. 6 is a diagram for describing an electric power control in the PDP device;

FIG. 7 is a diagram showing an entire structure of a plasma display device (PDP device) according to a second embodiment of the present invention;

FIG. 8 is a diagram showing driving waveforms (odd field) 6 of the PDP device according to the second embodiment; and

FIG. 9 is a diagram showing driving waveforms (even field) of the PDP device according to the second embodiment.

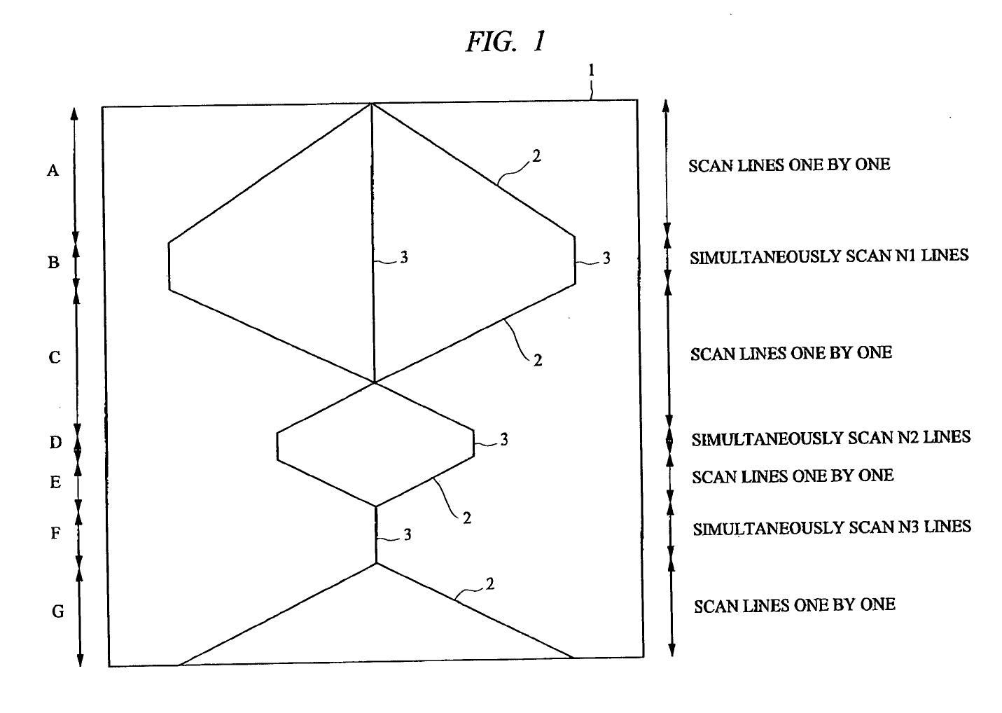

### DESCRIPTIONS OF THE PREFERRED EMBODIMENTS

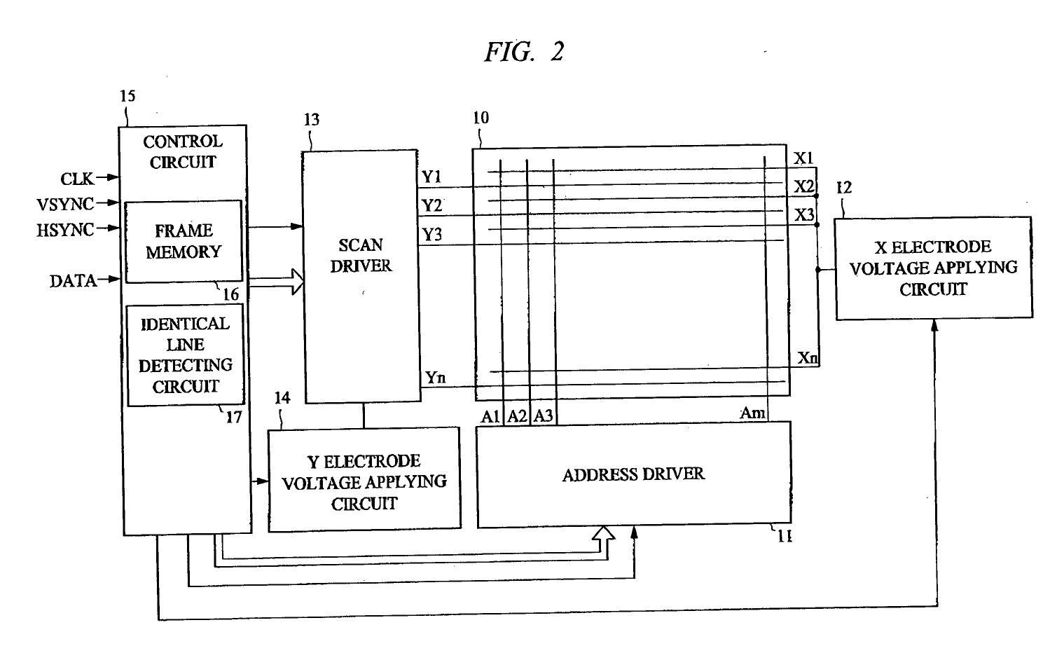

FIG. 2 is a diagram showing the entire structure of a plasma display device (PDP device) according to a first embodiment of the present invention. A reference numeral 10 denotes a three-electrode plasma display panel (PDP). In the PDP 10, a front substrate and a rear substrate are attached together, and discharge gas such as Ne—Xe is filled therebetween. On the front substrate, a plurality of sustain (X) electrodes and scan (Y) electrodes extending in a first (lateral) direction are alternately arranged, a dielectric layer is provided so as to cover the electrodes, and a protective film made of MgO is further provided thereon. On the rear substrate, a plurality of address electrodes extending in a second (longitudinal) direction perpendicular to the first direction are arranged, and a dielectric layer is provided so as to cover the electrodes. On the dielectric layer, barrier ribs are arranged so as to correspond to the spaces between the address electrodes, which divides the cells in the lateral direction. Further, on the dielectric layer on the address electrodes and the side surfaces of the barrier ribs, three kinds of phosphors which are excited by ultraviolet rays to generate red (R), green (G), and blue (B) visible lights are coated. Since the structure of the PDP has been already well known, further description thereof is omitted here.

The address electrodes of the PDP 10 are driven by an address driver 11, the sustain (X) electrodes are driven by an X electrode voltage applying circuit 12, and the scan (Y) electrodes are driven by a scan driver 13. A Y electrode voltage applying circuit 14 supplies, to the scan driver 13, a voltage to be applied to the Y electrodes in an address period and applies a predetermined voltage to the Y electrodes via the scan driver 13 in a reset period and a sustain period. A control circuit 15 receives image data DATA, clock signals CLK, vertical synchronization signals VSYNC, and horizontal synchronization signals HSYNC and generates signals for performing the display on the PDP 10 in accordance with the image data. The control circuit 15 has a frame memory 16 for expanding the image data into the data corresponding to the sub-fields and an identical line detecting circuit 17 for detecting the display identical lines on which the turned-on cells are identical in each sub-field from the image data expanded in the frame memory 16, and it generates and outputs signals for controlling the address driver 11, the X electrode voltage applying circuit 12, the scan driver 13, and the Y electrode voltage applying circuit 14. The control circuit 15 is composed of a computer system having a microprocessor and others. The identical line detecting circuit 17 is realized by a computer software program.

The control circuit 15 outputs control signals and address data of plural bits (for example, 32 bits) to the address driver 11. Also, in the present embodiment, the control circuit 15 outputs control signals and scan data of plural bits (for example, 32 bits) to the scan driver 13 as described later.

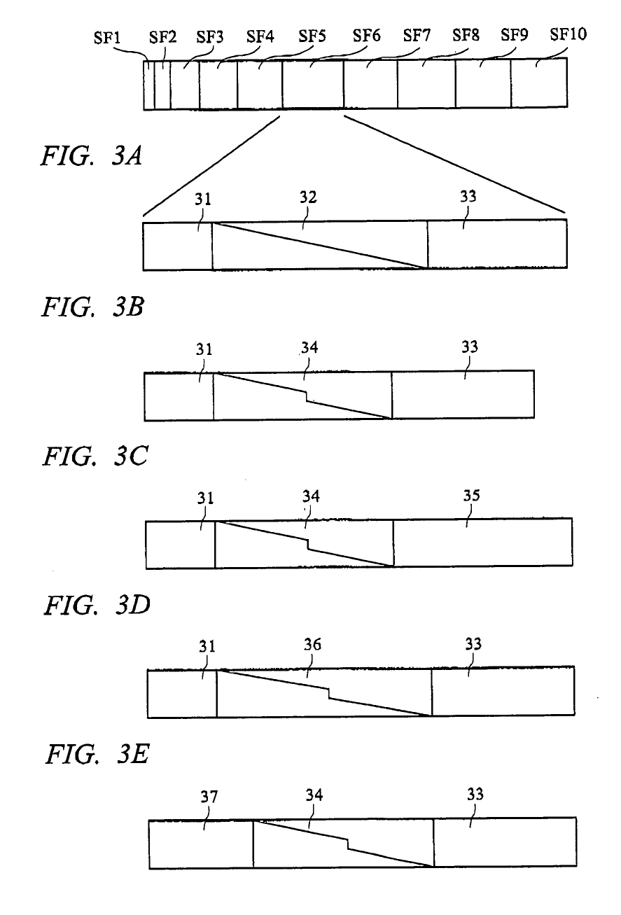

FIG. 3 shows examples of the configuration of the sub-fields for displaying images of one image field according to the first embodiment. As shown in FIG. 3A, one image field is composed of 10 sub-fields SF1 to SF10, and each sub-field is composed of a reset period 31, an address period 32, and a sustain period 33. In the reset period 31, wall charges formed in the sustain period in the immediately previous sub-field are erased and wall charges in the cells are rearranged so as to support the discharges in the following address period 32. In the address period 32, discharges are performed to select the cells to be turned on. Methods of selecting the cells to be turned on include a method of forming wall charges in the cells to be turned on and a method of erasing wall charges in the cells not to be turned on. The present embodiment employs the method of forming wall charges in the cells to be turned on, but the method is not limited to this. In the sustain period 33, discharges are repeatedly performed in the cells selected in the address period to turn on the cells.

Also, the sub-field SF6 in FIG. 3A shows the case where scan pulses are not simultaneously applied to a plurality of scan (Y) electrodes but sequentially applied to all the Y electrodes in the address period. In FIG. 3B to FIG. 3E, modified examples of the reset period 31, the address period 32, and the sustain period 33 in the case where scan pulses are simultaneously applied to a plurality of Y electrodes in the address period are shown. Although only the sub-field SF6 is shown in FIG. 3B to FIG. 3E, other sub-fields can be processed in the same manner.

In the case shown in FIG. 3B, the address period in the sub-field SF6 is shortened in such a manner that scan pulses are simultaneously applied to the plurality of lateral display lines having the identical image data, that is, to the plurality of (N) lateral display lines on which the positions of the turned-on cells in the lateral direction are identical to one another so that data is written to the plurality of (N) display lines in the time necessary to apply one scan pulse. The reset period 31 and the sustain period 33 are the same as those in FIG. 3A.

In the case shown in FIG. 3C, similar to the case of FIG. 3B, scan pulses are simultaneously applied to the plurality of lateral display lines having the identical image data to shorten the address period, and the sustain period 33 is increased by the time corresponding to the shortened time. Note that, when the sustain period 33 is to be increased, it is desirable to sum up the shortened times in the address periods in all of the sub-fields and allocate the total shortened times to the sustain periods 33 of respective sub-fields in accordance with the luminance ratio of each sub-field.

In FIG. 3D, scan pulses are simultaneously applied to the plurality of lateral display lines having the identical image data, and the width of the scan pulse is increased by the time corresponding to the shortened time. By doing so, it is possible to prevent the malfunction due to the discharge delay at the time of address discharge. Also in this case, it is desirable to sum up the shortened times in the address periods in all of the sub-fields and use the total shortened times to increase the width of the scan pulse in the sub-fields with a lower grayscale in which the discharge delay is large.

In FIG. 3E, similar to FIG. 3B, scan pulses are simultaneously applied to the plurality of lateral display lines having the identical image data to shorten the address period, and the reset period 31 is increased by the time corresponding to the shortened time. Also in this case, it is desirable to sum up the shortened times in the address periods in all of the sub-fields and to allocate the total shortened times to the reset periods 31 of each sub-field.

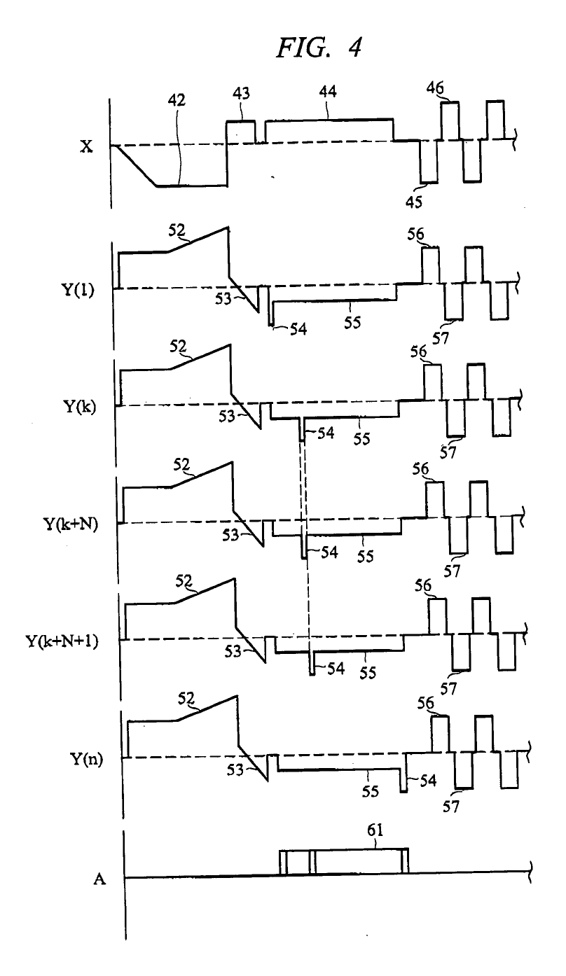

FIG. 4 is a diagram showing an example of the driving waveforms of each sub-field in the PDP device shown in FIG. 2. A reference character X denotes a driving waveform applied to the sustain (X) electrode, a reference character Y(1) denotes a driving waveform applied to the first scan (Y) electrode, a reference character Y(K) denotes a driving waveform applied to the K-th Y electrode, a reference character Y(K+N) denotes a driving waveform applied to the (K+N)-th Y electrode, a reference character Y(K+N+1) denotes a driving waveform applied to the (K+N+1)-th Y electrode, a reference character Y(n) denotes a driving waveform applied to the n-th (last) Y electrode, and a reference character A denotes a driving waveform applied to the address electrodes.

In the reset period, a voltage of 0 V is applied to the address electrode, a voltage 42 in which a voltage value gradually changes to a negative side and then keeps a predetermined value is applied to the X electrode, and a write obtuse wave 52 in which a voltage value changes to a positive side and then gradually increases is applied to all the Y electrodes. Consequently, reset discharges are generated between all the X and Y electrodes, and the wall charges are formed in all the cells. Subsequently, a positive voltage 43 is applied to the X electrodes and a compensation obtuse wave 53 which varies from a positive voltage near 0 V to a negative voltage is applied to the Y electrodes. Accordingly, the wall charges formed in all the cells are erased except a predetermined amount to be left. Thus, all the cells are made uniform in the reset period.

In the address period, a predetermined positive voltage 44 is applied to all the X electrodes. A negative voltage 55 is applied to the Y electrodes, and in this state, scan pulses 54 are sequentially applied while shifting the positions of the Y electrodes to which the scan pulses are applied. In synchronization with the application of the scan pulses, an address pulse 61 is applied to the address electrode. In this manner, address discharges are generated in the cells to which the scan pulses and the address pulse are simultaneously applied.

In this case, it is assumed that K-th to (K+N)-th lateral display lines have identical image data. Therefore, in the present embodiment, the scan pulses 54 are simultaneously applied to the K-th to (K+N)-th Y electrodes as shown in FIG. 4, and the address pulse 61 is applied to the address electrode in synchronization with the application of the scan pulses 54. Accordingly, address discharges are simultaneously generated in the cells to which the scan pulses and address pulse are applied in the K-th to (K+N)-th display lines.

Thereafter, the scan pulses are sequentially applied to the following electrodes until the last Y electrode, and the address operation is completed. Since an address operation for the N+1 lines is simultaneously performed as described above, the address period can be shortened by the time corresponding to the N lines.

Note that, the example in which the scan pulses 54 are simultaneously applied to the consecutive K-th to (K+N)-th Y electrodes has been described in FIG. 4. However, it is not always necessary that the Y electrodes to which the scan pulses are simultaneously applied are consecutive. Also, when there are three or more display identical lines, for example, there are 32 lines, the scan pulses can be applied to 16 Y electrodes twice instead of simultaneously applying the scan pulses to 32 Y electrodes.

After the address period has been finished, a negative wall charge is formed in the vicinity of the X electrode and a positive wall charge is formed in the vicinity of the Y electrode in the turned-on cells in which the address discharges are generated. In the cells not to be turned on in which address discharges are not generated, the state at the end of the reset period is maintained.

In the sustain period, the address electrode is held to 0 V, and a negative sustain pulse 45 and a positive sustain pulse 56 are applied to the X electrode and the Y electrode, respectively. Consequently, the voltage generated by wall charges is superposed to generate a sustain discharge in the turned-on cells, and a positive wall charge is formed in the vicinity of the X electrode and a negative wall charge, that is, a wall charge with an opposite polarity is formed in the vicinity of the Y electrode. In the cells not to be turned-on, the sustain discharge is not generated. Then, by applying a positive sustain pulse 46 and a negative sustain pulse 57 to the X electrode and the Y electrode respectively, the voltage generated by wall charges is superposed to generate a sustain discharge in the turned-on cells, and wall charges with opposite polarities are formed. Thereafter, by alternately applying the sustain pulses with different polarities, sustain discharges are repeatedly generated to turn on the cells.

In general, the scan pulse has a width of 1 μs to 2 μs. As shown in FIG. 3A to FIG. 3E, one display field is composed of 10 sub-fields. When two display lines have the same display data in each sub-field, a time of 10 μs to 20 μs can be shortened in one display field. If a period of the sustain pulse is 5 μs, the sustain pulse can be increased by two to four periods. When ten or more display lines have the same display data in each sub-field, a time of 100 μs to 200 μs can be shortened in one display field, and the sustain pulse can be increased by 20 to 40 periods.

Also, when a time of 100 μs to 200 μs can be shortened in one display field, the time can be also used to increase the width of the scan pulse. In the case where the width of the scan pulse is increased, it is desirable to increase the width of the scan pulse in a lower-grayscale sub-field in which the discharge delay is largest. For example, in the case of a 500-line panel, the width of the scan pulse in one low-grayscale sub-field can be widened by 0.2 μs to 0.4 μs, and the address discharge can be performed more stably.

It is also possible to allocate the shortened time to the reset period. When a time of 100 μs to 200 μs can be shortened in one display field, it is possible to increase the reset period in each sub-field by 10 μs to 20 μs so as to further stabilize the reset operation.

As described above, the larger the number of the display lines having the same display data, the more effective the present invention, and the time to be shortened can be increased. Provided that 200 or more display lines can be simultaneously written with other display lines, the sustain pulse can be increased by 400 to 800 periods in one display field. Since the period of the sustain pulse is typically about 1000 periods in one display field, the period of the sustain pulse can be increased to 1400 to 1800 periods and luminance can be increased by 1.4 to 1.8 times.

As described above, the PDP device according to the first embodiment requires that scan pulses are simultaneously applied to the plurality of Y electrodes and scan pulses are applied to the following Y electrodes while skipping the Y electrodes to which the scan pulses have been simultaneously applied. The scan driver 13 in FIG. 2 has conventionally used a driver IC having a shift register. However, the driver IC having a shift register cannot apply the driving waveforms according to the present embodiment.

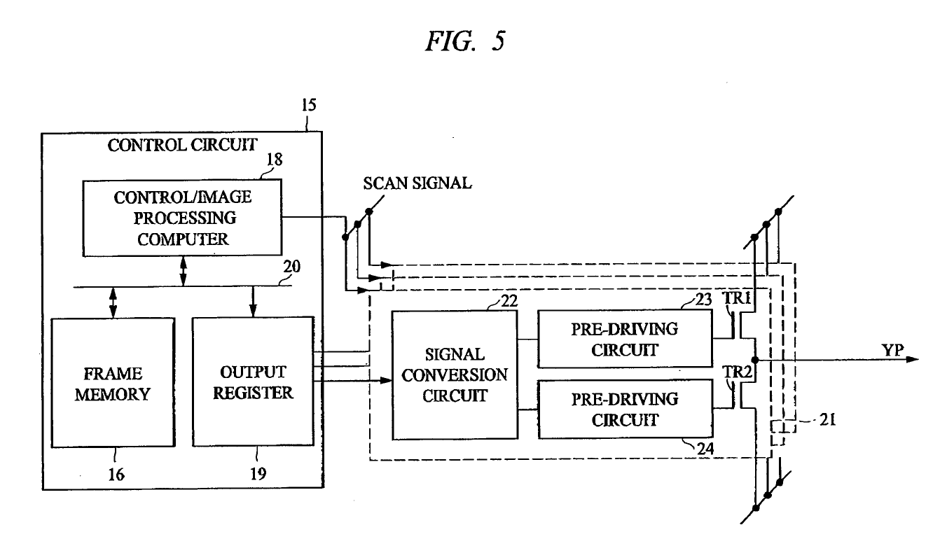

FIG. 5 is a diagram showing a structure of the scan driver 13 according to the present embodiment. A reference numeral 21 denotes a driving circuit for driving Y electrodes YP, and such driving circuits as many as the Y electrodes are provided. The scan driver 13 is realized by the use of a plurality of driver ICs with a plurality of driving circuits. Each driving circuit 21 has two transistors TR1 and TR2 connected in series between a high potential power supply terminal and a low potential power supply terminal connected in common. The connection node between the transistors TR1 and TR2 is connected to each Y electrode. The transistors TR1 and TR2 are, for example, MOSFETs or IGBTs. A voltage required for the reset, address, and sustain operations is supplied to the high potential power supply terminal and the low potential power supply terminal from the Y electrode voltage applying circuit 14.

Each driving circuit 21 receives a common scan control signal and an on/off signal for controlling the transistors TR1 and TR2 in each driving circuit from the control circuit 15. The scan control signal controls the driving circuits so as to output the scan pulse. Signal level of the on/off signal is converted in a signal conversion circuit 22, and then the on/off signal is applied to the gates of the transistors TR1 and TR2 via pre-driving circuits 23 and 24.

The control circuit 15 has a control/image processing computer 18, an output register 19, and a bus 20 for connecting them in addition to the frame memory 16. The identical line detecting circuit 17 shown in FIG. 2 is realized by the control/image processing computer 18. The frame memory 16 is composed of bit map memories corresponding to sub-fields. The identical line detecting circuit 17 detects and stores the display identical lines on which image data are identical in each sub-field expanded in the frame memory. It is also possible to provide plural kinds of the display identical lines. The control/image processing computer 18 writes output data to the output register 19 based on the stored data of the display identical lines in the address period. The output register 19 outputs the output data as an on/off signal at the timing of the output of the scan pulse. The control/image processing computer 18 rewrites the output data for each scan pulse. In this manner, it is possible to apply the scan pulses as shown in FIG. 4.

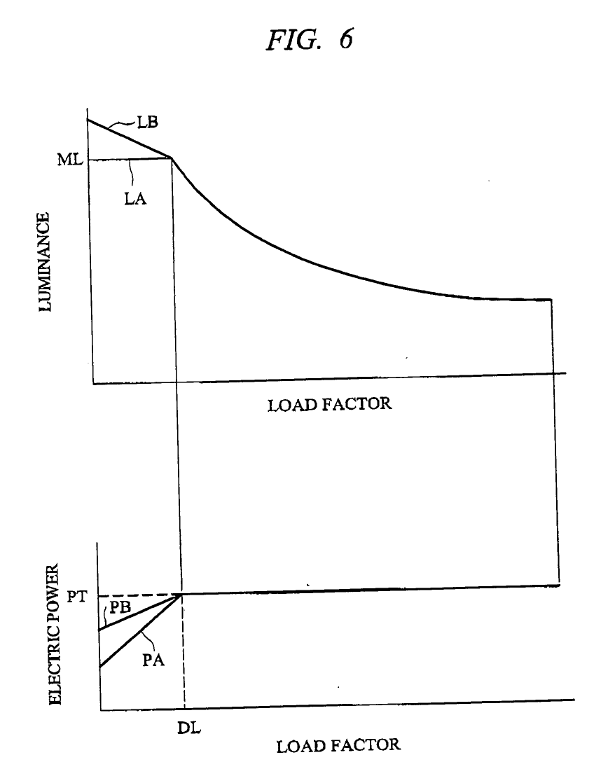

FIG. 6 is a diagram showing the variations in luminance and electric power with respect to the change in display load factor in Automatic Power Control (ARC) in which an electric power is controlled to be lower than a predetermined value PT in the PDP device. A horizontal axis represents a load factor. A vertical axis in the upper part of FIG. 6 represents luminance, and a vertical axis in the lower part of FIG. 6 represents an electric power. The power control is performed by the number of the sustain pulses in one display field. In a conventional PDP device, the maximum number of sustain pulses in one display field is determined. The number of sustain pulses in one display field is the maximum when a load factor is from zero to DL, and luminance determined by the number of sustain pulses in one display field is kept constant at ML. A reference character LA denotes a graph showing the luminance when a load factor is from zero to DL. A reference character PA denotes a graph showing the variation in electric power. When the load factor becomes DL, an electric power reaches a predetermined value PT and the further increase is not permitted. Then, when the load factor exceeds DL, the number of sustain pulses in one display field is reduced so that the electric power does not exceed the predetermined value PT. Accordingly, luminance depending upon the number of sustain pulses in one display field decreases from ML along with the increase of the load factor.

As stated above, in the present invention, the address period can be shortened by simultaneously applying the scan pulses to a plurality of Y electrodes. Even when the number of sustain pulses in one display field is increased by using the shortened time, it is necessary that an electric power does not exceed a predetermined value PT. As shown in FIG. 6, when a load factor is DL or higher, since the number of sustain pulses in one display field has to be decreased, the number of sustain pulses in one display field cannot be increased by using the time saved by shortening the address period. Therefore, the number of sustain pulses in one display field can be increased by using the time saved by shortening the address period only when a load factor is DL or lower. Reference characters LB and PB are graphs showing variations in luminance and electric power when power control is performed in the present embodiment, respectively. As shown in FIG. 6, it is obvious that LB in the present embodiment is higher than LA in the conventional example.

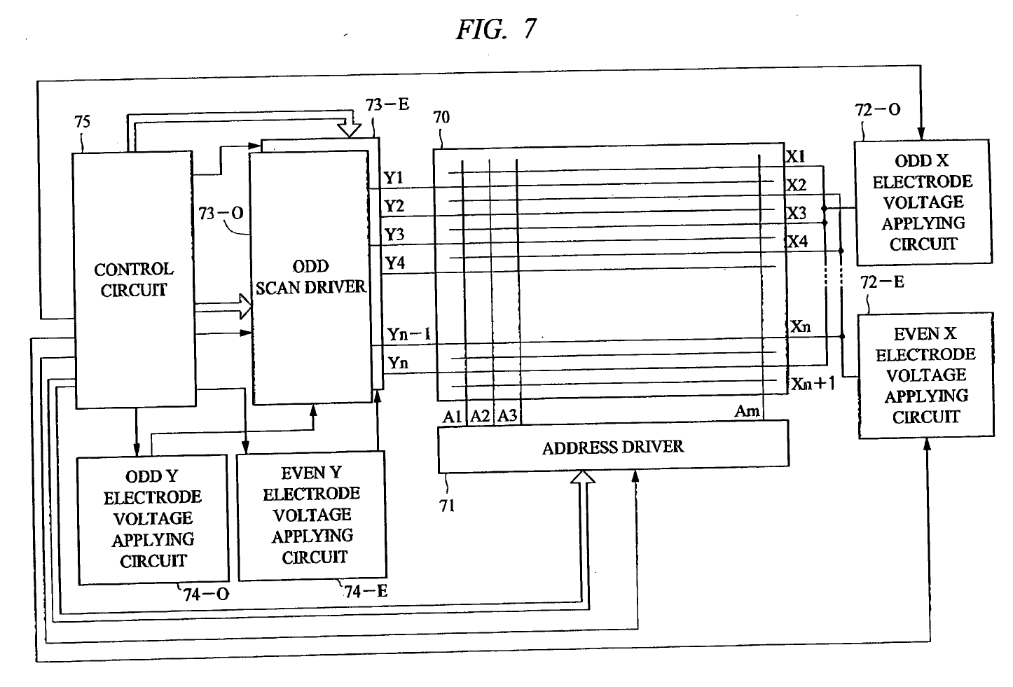

FIG. 7 is a diagram showing an entire structure of a PDP device according to a second embodiment of the present invention. The PDP device of the second embodiment is obtained by applying the present invention to an ALIS PDP device described in Japanese Patent Application Laid-Open Publication No. 9-160525 (Patent Document 4). The ALIS PDP70 is characterized in that X and Y electrodes are alternately provided and display lines are formed between all the X and Y electrodes to perform interlace display. The X electrodes are divided into odd-numbered X electrodes and even-numbered X electrodes. The odd-numbered X electrodes are driven in common by an odd X electrode voltage applying circuit 72-O, and the even-numbered X electrodes are driven in common by an even X electrode voltage applying circuit 72-E. The Y electrodes are divided into odd-numbered Y electrodes and even-numbered Y electrodes. The odd-numbered Y electrodes are driven by an odd scan driver 73-O, and the even-nuriered Y electrodes are driven by an even scan driver 73-E. An odd Y electrode voltage applying circuit 74-O supplies, to the odd scan driver 73-O, voltage required for applying scan pulses, and applies various kinds of voltages to the odd-numbered Y electrodes in common via the odd scan driver 73-O in the reset and sustain periods. An even Y electrode voltage applying circuit 74-E supplies, to the even scan driver 73-E, voltage required for applying scan pulses, and applies various kinds of voltages to the even-numbered Y electrodes in common via the even scan driver 73-E in the reset and sustain periods. An address driver 71 is the same in operation as the address driver 11 shown in FIG. 2. A control circuit 75 controls each part shown in FIG. 7 and includes a frame memory, a identical line detecting circuit and others similar to the control circuit 15 of the first embodiment shown in FIG. 2. Also, the odd scan driver 73-O and the even scan driver 73-E are controlled in the same manner as that in the first embodiment.

Since the ALIS PDP device is described in detail in the patent document 4, the detailed description thereof is omitted.

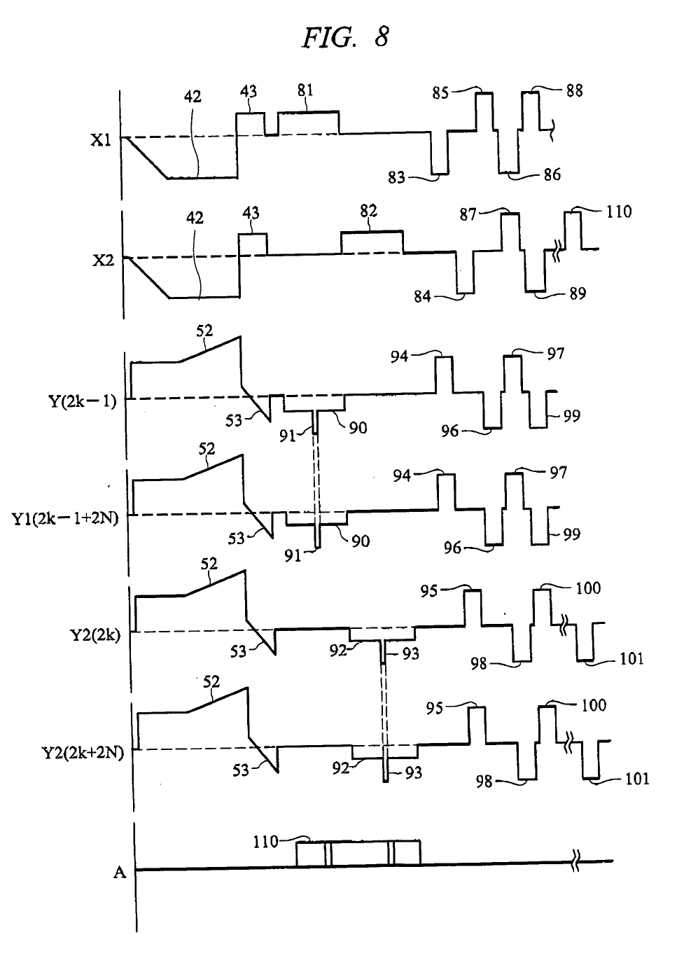

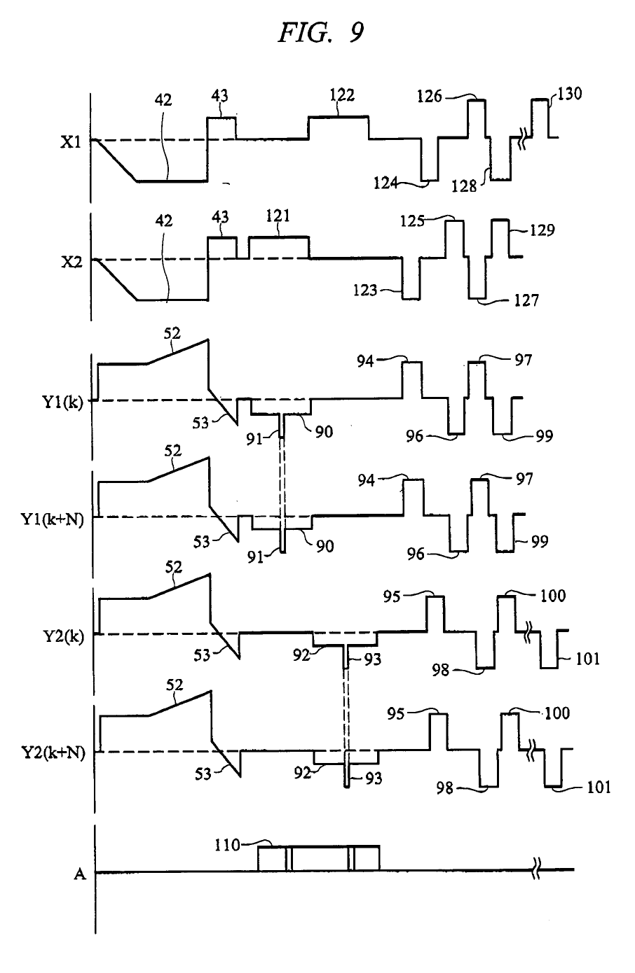

FIG. 8 is a diagram showing driving waveforms in odd fields of the PDP device according to the second embodiment, and FIG. 9 is a diagram showing driving waveforms in even fields of the PDP device according to the second embodiment. A reference character X1 denotes a driving waveform applied to the odd-numbered sustain (X) electrode, a reference character X2 denotes a driving waveform applied to the even-numbered X electrode, a reference character Y1(2K−1) denotes a driving waveform applied to the odd-numbered, that is, the (2K−1)-th Y electrode, a reference character Y1(2K−1+2N) denotes a driving waveform applied to the odd-numbered, that is, the (2K−1+2N)-th Y electrode, a reference character Y2(2K) denotes a driving waveform applied to the even-numbered, that is, the 2K-th Y electrode, and a reference character A denotes a driving waveform applied to the address electrode.

In the reset period, the same driving waveforms as those in the first embodiment are applied to the address electrodes, the X electrodes, and the Y electrodes.

The driving waveforms in the address and sustain periods are different between the odd field and the even field. Further, the address period is divided into the first half and the second half.

In the first half of the address period in the odd field, a positive voltage 81 is applied to the odd-numbered X electrodes, a voltage of 0 V is applied to the even-numbered X electrodes and even-numbered Y electrodes, and a negative voltage 90 is applied to the odd-numbered Y electrodes. In this state, scan pulses 91 are sequentially applied to the Y electrodes while shifting the positions of the Y electrodes, and in synchronization with this application of the scan pulses, address pulses 110 are applied to the address electrodes. Consequently, address discharges are generated in the cells to which the scan pulse and address pulse are simultaneously applied. At this time, since the positive voltage 81 is applied to the odd-numbered X electrodes, the address discharge acts as a trigger to generate an address discharge between odd-numbered Y electrodes and odd-numbered X electrodes and the wall charges are formed in the cells where the address discharge is generated. Since a voltage of 0 V is applied to the even-numbered X electrode, address discharge is not generated between odd-numbered Y electrodes and even-numbered X electrodes.

In this case, it is assumed that (2K−1)-th to (2K−1+2N)-th lateral display lines have the same image data. Thus, in the present embodiment, as shown in FIG. 8, scan pulses 91 are simultaneously applied to the (2K−1)-th to (2K−1+2)-th Y electrodes, and in synchronization with the application of the scan pulses, an address pulse 110 is applied to the address electrode. Consequently, the address discharges are simultaneously generated in the cells, to which the scan pulse and address pulse are applied, on the (2K−1)-th to (2K−1+2)-th display lines. Thereafter, scan pulses are sequentially applied to the following odd-numbered Y electrodes until the last Y electrode, and the first half of the address operation is finished.

In the second half of the address period in the odd field, a positive voltage 82 is applied to the even-numbered X electrodes, a voltage of 0 V is applied to the odd-numbered X electrodes and odd-numbered Y electrodes, and a negative voltage 92 is applied to the even-numbered Y electrodes. In this state, scan pulses 92 are sequentially applied to the even-numbered Y electrode while shifting the positions of the Y electrodes, and in synchronization with the application of the scan pulses, an address pulse 110 is applied to the address electrode. Consequently, address discharges are generated in the cells to which the scan pulse and address pulse are simultaneously applied. At this time, since the positive voltage 82 is applied to the even-numbered X electrodes, the address discharge acts as a trigger to generate an address discharge between even-numbered Y electrodes and even-numbered X electrodes and the wall charges are formed in the cells where address discharges are generated. Since a voltage of 0 V is applied to the odd-numbered X electrodes, address discharge is not generated between even-numbered Y electrodes and odd-numbered X electrodes.

Similarly, it is assumed that 2K-th to (2K+2N)-th lateral display lines have the same image data. Thus, in the present embodiment, as shown in FIG. 8, scan pulses 93 are simultaneously applied to the 2K-th to (2K+2N)-th Y electrodes, and in synchronization with the application of the scan pulses, an address pulse 110 is applied to the address electrode. Consequently, address discharges are simultaneously generated in the cells, to which the scan pulse and address pulse are applied, on the 2K-th to (2K+2N)-th display lines. Thereafter, scan pulses are sequentially applied to the following even-numbered Y electrodes until the last Y electrode, and the second half of the address operation is finished.

When the address period is finished, a negative wall charge is formed in the vicinity of the X electrode and a positive wall charge is formed in the vicinity of the Y electrode in the turned-on cells in which the address discharges are generated. In the cells not to be turned on in which the address discharges are not generated, the state at the end of the reset period is maintained.

In the second embodiment, similar to the first embodiment, since an address operation required for N lines is simultaneously performed, an address period can be shortened by the time corresponding to the N lines.

In the sustain period in the odd field, the address electrodes are held to 0 V and a voltage of 0 V is applied to the even-numbered X electrodes and even-numbered Y electrodes. In this state, a negative sustain pulse 83 and a positive sustain pulse 94 are applied to the odd-numbered X electrode and the odd-numbered Y electrode, respectively. Consequently, the voltage generated by wall charges is superposed to generate a sustain discharge in the turned-on cells on display lines formed by odd-numbered X electrodes and odd-numbered Y electrodes, and a positive wall charge is formed in the vicinity of the X electrode and a negative wall charge, that is, a wall charge with an opposite polarity is formed in the vicinity of the Y electrode. In the cells not to be turned on, a sustain discharge is not generated. Next, the odd-numbered X electrodes and odd-numbered Y electrodes are held to 0 V. In this state, a negative sustain pulse 84 and a positive sustain pulse 95 are applied to the even-numbered X electrodes and the even-numbered Y electrodes, respectively. Consequently, the voltage generated by wall charges is superposed to generate a sustain discharge in the turned-on cells on display lines formed by the even-numbered X electrodes and even-numbered Y electrodes, and a positive wall charge is formed in the vicinity of the X electrode and a negative wall charge, that is, a wall charge with an opposite polarity is formed in the vicinity of the Y electrode. In the cells not to be turned on, the sustain discharge is not generated.

Next, a voltage of 0 V is applied to the even-numbered X electrodes and even-numbered Y electrodes. In this state, a positive sustain pulse 85 and a negative sustain pulse 96 are applied to the odd-numbered X electrodes and the odd-numbered Y electrodes, respectively. Consequently, the voltage generated by wall charges is superposed to generate a sustain discharge in the turned-on cells on display lines formed by the odd-numbered X electrodes and odd-numbered Y electrodes, and a negative wall charge is formed in the vicinity of the X electrode and a positive wall charge is formed in the vicinity of the Y electrode.

Subsequently, a negative sustain pulse 86 is applied to the odd-numbered X electrodes, a positive sustain pulse 87 is applied to the even-numbered X electrodes, a positive sustain pulse 97 is applied to the odd-numbered Y electrodes, and a negative sustain pulse 98 is applied to the even-numbered Y electrodes, respectively. Consequently, the voltage generated by wall charges is superposed to generate a sustain discharge in the turned-on cells on the display lines formed by the odd-numbered X electrodes and odd-numbered Y electrodes and in the turned-on cells on the display lines formed by the even-numbered X electrodes and even-numbered Y electrodes, and the wall charges in the vicinity of respective electrodes are reversed.

Thereafter, by applying sustain pulses while reversing polarities thereof, sustain discharges are repeatedly generated, and the cells are turned on.

The number of times of sustain discharges in the turned-on cells on the display lines formed by the even-numbered X electrodes and even-numbered Y electrodes is smaller by once in comparison with the number of times of sustain discharges in the turned-on cells on the display lines formed by the odd-numbered X electrodes and odd-numbered Y electrodes. Therefore, a positive sustain pulse 110 is applied to the even-numbered X electrodes and a negative sustain pulse 101 is applied to the even-numbered Y electrodes in the last place to match the number of times of light emissions.

As described above, in the odd field, the display lines formed by the odd-numbered X electrodes and the odd-numbered Y electrodes and the display lines formed by the even-numbered X electrodes and the even-numbered Y electrodes are displayed.

The driving waveforms in the even field are the same as those of the odd field except that the waveforms applied to the odd-numbered X electrodes and to the even-numbered X electrodes are interchanged. In the even field, the display lines formed by the odd-numbered Y electrodes and the even-numbered X electrodes and the display lines formed by the even-numbered Y electrodes and the odd-numbered X electrodes are displayed.

As described above, in the case of the ALIS method, in the odd field, the simultaneous writing of the display lines having the same display data among those formed by the odd-numbered X electrodes and the odd-numbered Y electrodes can be performed, and also the simultaneous writing of the display lines having the same display data among those formed by the even-numbered X electrodes and the even-numbered Y electrodes can be performed. In the even field, the simultaneous writing of the display lines having the same display data among those formed by the odd-numbered Y electrodes and the even-numbered X electrodes can be performed, and also the simultaneous writing of the display lines having the same display data among those formed by the even-numbered Y electrodes and the odd-numbered X electrodes can be performed.

According to the present invention, display quality and stability of the PDP device can be improved, and thus, it is possible to provide a high-quality and reliable plasma display device which can be used for various applications.

What is claimed is:

1. A driving method of a plasma display panel having a plurality of scan and sustain electrodes alternately arranged in parallel to each other and address electrodes arranged in a direction perpendicular to said plurality of scan and sustain electrodes,
wherein one display field includes a plurality of sub-fields, and each sub-field comprises: a reset period in which all cells are initialized; an address period in which scan pulses are sequentially applied to said scan electrodes, and address pulses are applied to said address electrodes in synchronization with said application of the scan pulses, thereby generating address discharges to select cells to be turned on; and a sustain period in which sustain discharges are repeatedly generated between said scan electrodes and said sustain electrodes of the turned-on cells selected in said address period, thereby turning on the cells,
display identical lines on which the turned-on cells on one line are identical are detected in each sub-field, and
said scan pulses are simultaneously applied to a plurality of scan electrodes corresponding to said display identical lines in said address period.

2. The driving method of a plasma display panel according to claim 1,
wherein the number of times of said sustain discharges is increased when said address period is shortened by simultaneously applying said scan pulses to the plurality of scan electrodes.

3. The driving method of a plasma display panel according to claim 2,
wherein the number of times of said sustain discharges is controlled so that electric power does not exceed a predetermined value in accordance with display load, and
the number of times of said sustain discharges is increased when said electric power is lower than said predetermined value.

4. The driving method of a plasma display panel according to claim 3,
wherein, even when the number of times of said sustain discharges is increased, said electric power is controlled so as not to exceed said predetermined value.

5. The driving method of a plasma display panel according to claim 1,
wherein a width of said scan pulse is widened when said address period is shortened by simultaneously applying said scan pulses to the plurality of scan electrodes.

6. The driving method of a plasma display panel according to claim 1,
wherein said reset period is lengthened when said address period is shortened by simultaneously applying said scan pulses to the plurality of scan electrodes.

7. The driving method of a plasma display panel according to claim 1,
wherein said display identical lines are detected from image data expanded in a frame memory corresponding to said plurality of sub-fields.

8. A plasma display device comprising:
a plasma display panel having a plurality of scan and sustain electrodes alternately arranged in parallel to each other and address electrodes arranged in a direction perpendicular to said plurality of scan and sustain electrodes;
a scan electrode driving circuit for driving said scan electrodes;
a sustain electrode driving circuit for driving said sustain electrodes; and
an address electrode driving circuit for driving said address electrodes,
wherein one display field includes a plurality of sub-fields, and each sub-field comprises; a reset period in which all cells are initialized; an address period in which scan pulses are sequentially applied to said scan electrodes, and address pulses are applied to said address electrodes in synchronization with said application of the scan pulses, thereby generating address discharges to select cells to be turned on; and a sustain period in which sustain discharges are repeatedly generated between said scan electrodes and said sustain electrodes of the turned-on cells selected in said address period, thereby turning on the cells,
an identical line detecting circuit for detecting display identical lines on which the turned-on cells on one line are identical in each sub-field is provided, and
said scan electrode driving circuit simultaneously applies said scan pulses to a plurality of scan electrodes corresponding to said display identical lines in said address period.
